(19) United States
(12) Patent Application Publication
(10) Pub. No.: US 2012/0285874 A1
(43) Pub. Date: Nov. 15, 2012

(54) IMMERSION TYPE MEMBRANE MODULE UNIT AND MEMBRANE SEPARATION ACTIVATED SLUDGE PROCESS EQUIPMENT

(75) Inventors: Toru Morita, Sennan-gun (JP); Yoshimasa Watanabe, Sapporo-shi (JP)

(73) Assignees: NATIONAL UNIVERSITY CORPORATION HOKKAIDO UNIVERSITY, Sapporo-shi ,Hokkaido (JP); SUMITOMO ELECTRIC FINE POLYMER ,INC., Sennan-gun ,Osaka (JP)

(21) Appl. No.: 13/574,352

(22) PCT Filed: Jun. 29, 2011
(86) PCT No.: PCT/JP2011/064900

§ 371 Date: Jul. 20, 2012

(30) Foreign Application Priority Data
Jun. 30, 2010 (JP) 2010-150586

(51) Int. Cl. B01D 65/02; B01D 63/02

(52) U.S. Cl. 210/151

(57) ABSTRACT

An immersion type membrane module unit includes: an immersion type membrane module for membrane separation activated sludge filtration; an extended wall extending from a lower end of the membrane module and surrounding a space downward of the membrane module; and a membrane aerating air diffusion device disposed at one of a lower portion in the space and a position around and downward of the space and having a plurality of air diffusion holes arranged in a plane, and the membrane module has separation membranes with gaps therebetween and the extended wall receives bubbles output through the air diffusion holes and guides the bubbles to the gaps.

### TECHNICAL FIELD

The present invention relates to an immersion type membrane module unit for membrane separation activated sludge filtration, and membrane separation activated sludge process equipment providing membrane cleaning aeration by the module unit and also separately providing bioaeration.

### BACKGROUND ART

Conventionally, water treatment equipment employing a membrane separation activated sludge process has been proposed, and some such equipment is put in practical use in applications, such as septic tanks, agricultural effluent treatment, industrial effluent treatment, and municipal sewage treatment. The membrane separation activated sludge process employs membrane to provide microseparation and thus not only provides treated water of good quality but also allows activated sludge to have high concentration, which in turn allows an activated sludge vessel to have an increased ability to decompose organic matters per volume and accordingly have a reduced size, which in turn allows a smaller footprint, a reduced construction cost and the like advantages. It is thus believed that this technique will widely be used in future.

When membrane separation with activated sludge of high concentration is performed, significantly viscous activated sludge floc adheres to the membrane and contributes to contamination and hence a significantly impaired processing ability. To prevent this, constant aeration is provided under a membrane module to vibrate the membrane or cause bubbles to ascend to provide sludge with a difference in density to cause a swirling stream near the membrane module to remove activated sludge deposited on a surface of the membrane (hereinafter this operation will be referred to as membrane cleaning aeration or membrane aeration). Thus in reality a physical cleaning process using bubbles is constantly required and performed. Furthermore, as well as done for a conventional standard activated sludge process, aeration is also performed as a means to supply activated sludge with oxygen to maintain an ability of the activated sludge to decompose dissolved organic matters (hereinafter this operation will be referred to as bioaeration). The membrane separation activated sludge process thus requires both membrane cleaning aeration and bioaeration, and when it is compared with conventional, standard activated sludge, the former additionally requires membrane cleaning aeration and hence more energy, and reducing it is an issue to be addressed.

Immersion type membrane separation activated sludge processes are generally categorized into two systems, as described in non patent literature 1. One is a conventional basic type having a biotreatment vessel, i.e., a single vessel, with a membrane module inserted therein. It is a type with an integrated vessel and thus advantageously compact. The other is a type with separate vessels to weigh flexibility in the membrane module's filtration system, chemical cleaning, and the like, that is, a system is widely used in which a biotreatment vessel and a membrane separation vessel are separately provided and activated sludge circulates through the two vessels.

### CITATION LIST

### Non Patent Literature

Non Patent Literature 1: Water Utilization Technology through Membrane Bioreactor (MBR), edited by Kazuo YAMAMOTO, Science & Technology Co., Ltd., Feb. 19, 2010

### SUMMARY OF INVENTION

### Technical Problem

However, each type has an issue to be addressed. The single-vessel type, in most cases, utilizes a biotreatment aeration device to also perform membrane cleaning aeration, i.e., one device serves for two roles, and aerating bubbles may ineffectively be applied to the membrane module and the amount of air supplied may ineffectively be used. Accordingly, a large amount of air for aeration is required to sufficiently effectively clean a surface of a membrane of the membrane module. As a result, when it is compared with a standard activated sludge process, the former requires significantly larger total aeration energy.

The type with separated vessels has two vessels fabricated separately, which prevents a membrane separation activated sludge process from exhibiting its characteristic advantage, i.e., compactness, and it also requires a pump or the like for circulation through the two vessels, which is against energy cost reduction.

The present invention has been made in view of the above issues, and it contemplates an immersion type membrane module unit for membrane separation, that can maintain advantageous compactness of membrane separation activated sludge process and also achieve reduced aeration energy, and novel membrane separation activated sludge process equipment employing the same.

### Solution to Problem

To solve the above problems, the present invention provides an immersion type membrane module unit including: an immersion type membrane module for membrane separation activated sludge filtration; an extended wall extending from a lower end of the membrane module and surrounding a space downward of the membrane module; and a membrane aerating air diffusion device disposed at one of a lower portion in the space and a position around and downward of the space and having a plurality of air diffusion holes arranged in a plane, the membrane module having separation membranes with gaps therebetween, the extended wall receiving bubbles output through the air diffusion holes, and guiding the bubbles to the gaps.

The present membrane module unit allows the bubbles jetted by the air diffusion device to be supplied to the membrane module's entire area uniformly, and can also reduce bubbles divergent outward from a space under the membrane module and thus supply the membrane module with sufficient bubbles. This can contribute to a reduced amount of air to be supplied and hence a reduced amount of energy used for aeration to clean membrane.

This membrane module unit can have the air diffusion device adapted to have an upper surface covering the membrane module's projected area and provided with a plurality of air diffusion holes. Bubbles are supplied to the membrane module's entire area uniformly through the air diffusion holes provided in the upper surface of the air diffusion device that covers the membrane module's projected area. The air diffusion holes can have a diameter for example of 1-8 mm, desirably 3-6 mm, to generate coarse bubbles suitable for cleaning the membrane. Thus, vibration, a swirling stream and the like effective for cleaning the membrane are caused from the bubbles' ascending velocity, magnitude in energy, and the like.

The present invention in a preferable embodiment can provide the plurality of air diffusion holes uniformly to correspond to the gaps between the separation membranes. This allows the separation membrane to be cleaned uniformly and appropriately. The separation membrane module for example at its upper end has separation membranes mutually spaced and thus adjacently disposed, and mutually secured by a sealing member. In contrast, the separation membrane module at its lower end is not provided with the sealing member and can instead be provided with a support rod or the like to: for example have the separation membranes folded around the support rod and thus secured and spaced; or for example secure the separation membranes at their lower ends only partially to the support rod or the like to have half free ends and thus easily sway.

When the air diffusion holes have a large distance to the separation membrane module's lower end, i.e., when the extended wall has a large length, the bubbles jetted through the air diffusion holes are increased and thus become coarser, larger bubbles as they ascend inside the extended wall. This allows the separation membrane module to have the separation membrane exposed to larger bubbles and thus effectively swayed.

Furthermore, while, as well as done for the upper end, a sealing material is introduced between the separation membranes to secure them, a through hole or the like may be provided at a portion that does not have the separation membranes to serve as a hole to therethrough supply raw water, introduce bubbles and the like. Preferably, the gaps between the separation membranes provided at the lower end or a through hole of a sealing layer are opposite to the air diffusion holes so that the gaps pass bubbles and thus introduce and cause bubbles to ascend between the membranes of the membrane module. The separation membrane module has a lower end externally surrounded by a frame, which is attached for example via a coupling frame to a frame securing an upper end of the separation membrane module.

The separation membrane module can be a hollow fiber membrane module or a flat sheet membrane module. The separation membrane module may have a separation membrane of any material. Desirably, however, it is formed of a soft material that can be vibrated by energy caused as bubbles ascend. Organic material, poly-tetrafluoroethylene (PTFE) in particular, is preferably used to form the membrane. The separation membrane of PTFE is strong and when it has a surface continuously exposed to diffused air it is not damaged or creased and can thus exhibit durability. Furthermore, the PTFE membrane can be adapted to be larger in porosity than other materials, and as a result can be smaller in weight, and as it is a soft material, it is vabratable.

Furthermore, the PTFE membrane has large strength and is excellent in chemical resistance, chemical stability and weather resistance, and in particular, when the membrane has a surface soiled with an effluent component, activated sludge and the like it can be cleaned with an alkaline liquid of high concentration, an oxidizer, an acidic liquid and the like.

The membrane module can be formed with hollow fiber membranes of PTFE bundled together. As the hollow fiber membrane of PTFE, Poreflon® produced by Sumitomo Electric Fine Polymer, Inc. can suitably be used.

The membrane separation activated sludge process equipment with a separation membrane module having a separation membrane, to which floc adheres, formed of hollow fiber membrane of PTFE can be operated durably against continuous air diffusion. Furthermore, if the hollow fiber membrane has a surface with floc, a poorly soluble component and/or the like deposited thereon, it can be cleaned with an alkaline liquid of high concentration, an oxidizer, an acidic liquid and the like and thus treat water while maintaining a high permeable flow rate stably for a long period of time.

The hollow fiber membrane of PTFE is a single or multiple layers formed of porous membrane of expanded PTFE. A multilayered hollow fiber is suitably implemented as a porous, multilayered hollow fiber membrane described in Japanese Patent No. 3851864 referenced and cited herein, or the like, and a separation membrane module having hollow fiber bundled together is suitably implemented as hollow fiber membrane modules described in Japanese Patent Nos. 3077260 and 3851864 referenced and cited herein.

Hollow fiber membrane of expanded PTFE, as described above, is excellent in strength, durability and corrosion resistance and can exhibit significant usefulness in treating significantly turbid effluent. Furthermore, as porous membrane of expanded PTFE is produced through an extrusion and stretching process, advanced molecular orientation allows micropores to be provided at high porosity. This allows a filtration membrane to provide a large amount of permeating water and thus be of high performance and to also undergo air diffusion and thus be swayed without having a separation membrane cracked or broken and thus exhibit excellent durability.

Preferably, the hollow fiber membrane formed of porous membrane of expanded PTFE preferably for example has a filtering area having an average pore diameter of 0.01 μm or larger, an average thickness of 0.1-10 mm, a porosity of 40-90%, and a tensile strength of 10N/mm² or larger as defined in JIS K 7113.

In particular, the average pore diameter is preferably 0.01-5.0 μm, further desirably 0.1-0.45 μm. The average pore diameter can be measured with a perm porometer produced by Porous Materials Inc. (model CFP-1200A).

The average thickness is measured with a dial gauge. The porosity is measured in a method described in ASTM D792.

The expanded porous PTFE refers to PTFE having a porosity of 60% or larger, preferably 80% or larger.

The present invention in another embodiment provides membrane separation activated sludge process equipment of a single vessel type providing biotreatment and membrane separation within a single vessel, having in an activated sludge tank: the above described immersion type membrane module unit; and a bioaerating air diffusion device underlying the membrane module unit and independent of the air diffusion device provided to supply oxygen to activated sludge.

The present membrane separation activated sludge process equipment allows a necessary and sufficient amount of air to be used to perform membrane cleaning aeration throughout the membrane module's entire area uniformly and independently thereof provides bioaeration in the same vessel. The membrane separation activated sludge process equipment can thus avoid having an increased size and reduce total aeration energy required.

In the membrane separation activated sludge process equipment, an air diffusion device of the immersion type membrane module unit can supply the separation membrane module with coarse bubbles for membrane cleaning aeration and the bioaerating air diffusion device can supply fine bubbles. The coarse bubbles can cause vibration and a swirling stream effective for cleaning the membrane.

The bioaerating air diffusion device can have holes having a diameter for example of 0.1-1 mm, and the bubbles can for example be approximately 0.2-2 mm in diameter. To ensure that activated sludge provides satisfactory throughput, an appropriate dissolved oxygen concentration is required. The oxygen concentration is 1-3 mg/l, and the present invention employs the above described membrane cleaning aeration to dissolve oxygen into activated sludge. However, this may not dissolve oxygen in an amount that satisfies that required by activated sludge, and accordingly, a biotreatment aeration means is assistively provided. In that case, a bioaerating air diffusion device capable of generating fine bubbles can be provided under the membrane module unit to supply required dissolved oxygen without increasing the activated sludge tank's footprint. The bioaerating air diffusion device can provide bubbles small in diameter and hence dissolution more efficiently, and as a result achieve a reduced amount of oxygen to be supplied and hence reduced aeration energy required. A single bioaerating air diffusion device can be located under one or more hollow fiber membrane modules.

Furthermore, in particular, the bioaerating air diffusion device is disposed at a lower portion of an area in which the membrane module unit exists to allow ascending bioaerating bubbles to flow in the same direction as membrane cleaning aeration, and as a result membrane cleaning aeration and biotreatment aeration can provide swirling streams, respectively, in the same direction, which amplify each other to provide an enhanced cleaning effect.

Bioaeration and membrane aeration can be connected via air supply pipes of different systems. For example, their respective pipes extending along a side wall of the activated sludge tank have their respective lower ends bent horizontally and thus connected to the bioaerating air diffusion device and the membrane aerating air diffusion device, respectively, and the bioaerating air diffusion device is disposed parallel to a bottom wall of the tank and has an upper surface having a plurality of fine air diffusion holes to jet air therethrough, while the membrane aerating air diffusion device can be attached via an extended wall coupled with a frame externally surrounding a lower end of the separation membrane module, and has an upper surface having a plurality of air diffusion holes to jet air therethrough toward the separation module's projected area thoroughly.

For the bioaerating air diffusion device, fine air diffusion holes can be provided in an upper surface of an air supply pipe extending along a bottom surface of the tank or a tubular air diffusion device generating fine bubbles may be provided at an intermediate portion of the pipe.

The membrane separation activated sludge process equipment can further include a control device to control the membrane aerating air diffusion device and the bioaerating air diffusion device independently.

Specifically, the bioaerating air supply pipe and the membrane aerating air supply pipe can be provided with automatic opening/closing valves, respectively, opened/closed as controlled by the control device, and the flow rate of air supplied and when to supply air (or when to provide air diffusion/aeration), the flow rate of raw water supplied and when to supply raw water, the suction and permeation flow rate of the liquid permeating through the membrane, and the like can be obtained via a dissolved oxygen meter or by monitoring a transmembrane pressure difference indicating how the membrane is fouled and a signal indicative thereof can be issued and in response thereto, bioaeration and membrane aeration can totally be controlled in amount to prevent fouling and excessive/insufficient dissolved oxygen to operate the entire water treatment apparatus efficiently. Note that the automatic opening/closing valve is an electromagnetic valve, and preferably, the electromagnetic valve is also manually operable.

### Advantageous Effects of Invention

As set forth above, the present invention can maintain advantageous compactness of membrane separation activated sludge process and also allows the system as a whole to require reduced energy for aeration.

### BRIEF DESCRIPTION OF DRAWINGS

FIG. 1 is a plan view of membrane separation activated sludge process equipment of a first embodiment of the present invention.

FIG. 2 is a cross section taken along a line A-A of FIG. 1.

FIG. 3 is a cross section taken along a line B-B of FIG. 1.

FIG. 4 shows an automatically controlled circuit.

FIG. 5(A) shows a hollow fiber membrane module in a perspective view, and FIG. 5(B) shows a main portion thereof in cross section.

FIGS. 6(A), 6(B), and 6(C) show an air diffusion box in a plan view, a front view, and a side view, respectively.

FIG. 7(A) shows a hollow fiber membrane module having a lower end with an air diffusion box attached thereto, as seen in a front view, and FIG. 7(B) shows an attachment unit in an enlarged cross section.

FIG. 8 shows a main portion of the first embodiment in an exemplary variation in cross section.

FIG. 9 shows a main portion of a second embodiment.

FIG. 10 shows a hollow fiber membrane module in a third embodiment in a perspective view.

FIG. 11 shows membrane separation activated sludge process equipment of an exemplary experiment, with FIG. 11(A) schematically showing an example of the present invention, and FIG. 11(B) schematically showing a comparative example.

FIGS. 12(A) to 12(D) are tables indicating a result of measuring the example of the present invention and the comparative example.

### DESCRIPTION OF EMBODIMENTS

Hereinafter, the present invention in embodiments will be described with reference to the drawings.

The present embodiment provides membrane separation activated sludge process equipment to purify sewage, industrial effluent and the like and have a single vessel receiving microorganisms of high concentration for biotreatment and also having a separation membrane module suspended therein, i.e., of an in-vessel type.

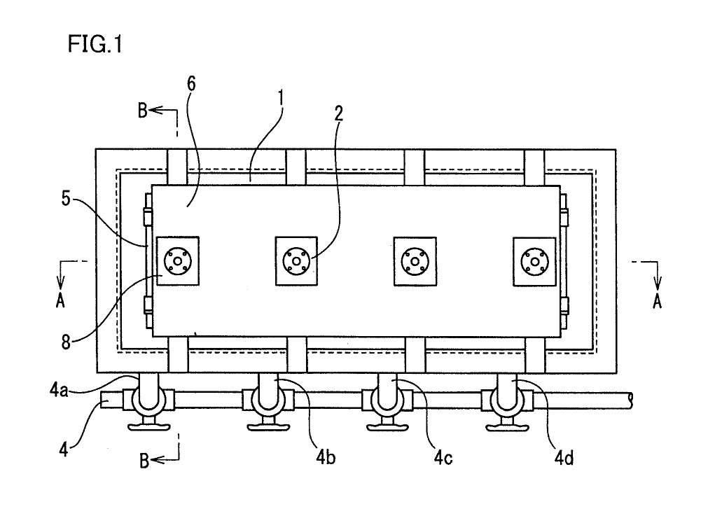

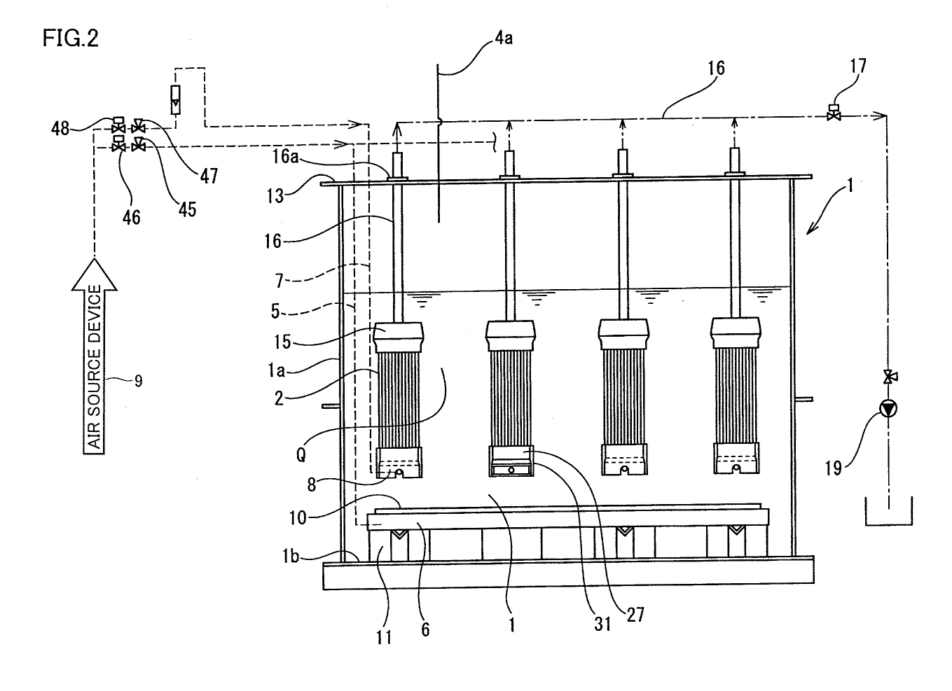

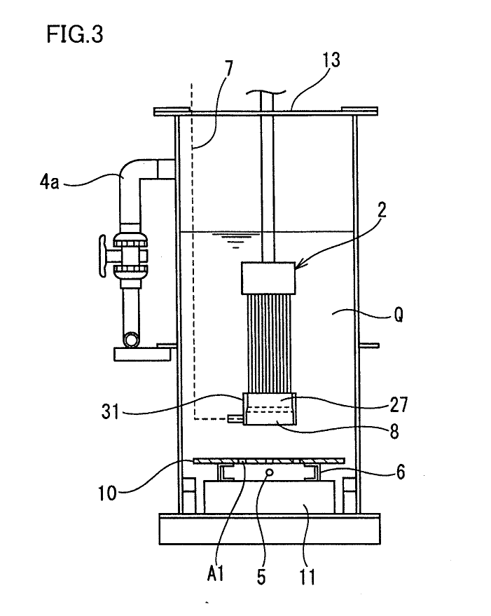

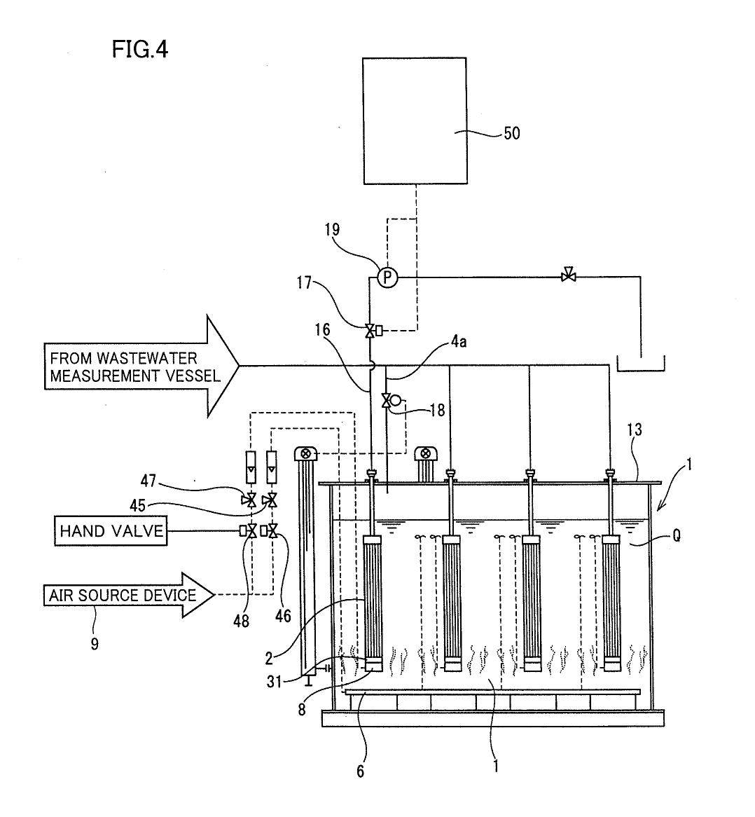

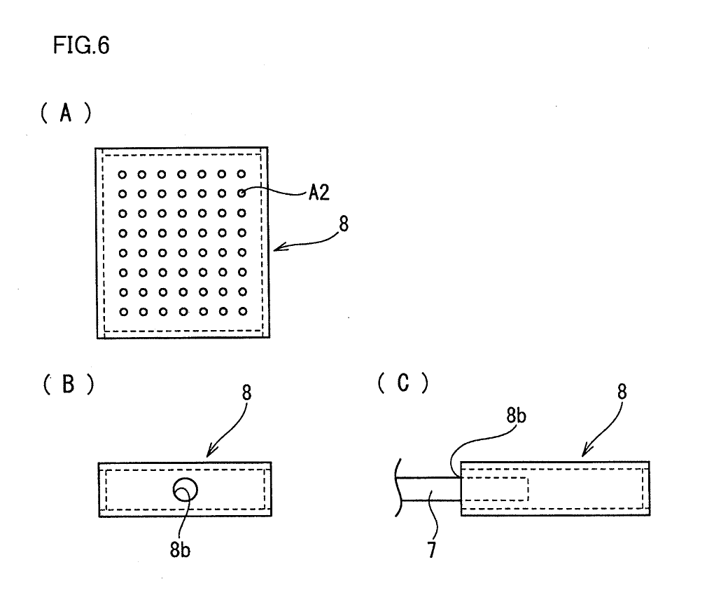

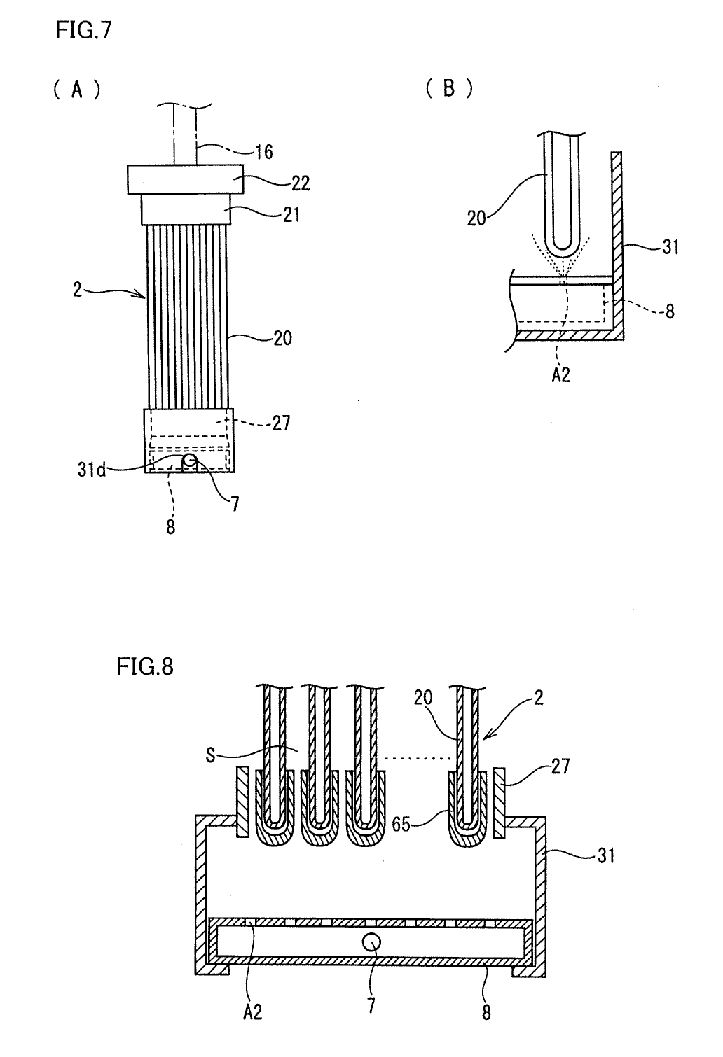

FIG. 1 to FIG. 7 show a first embodiment, which has a vessel 1 with a plurality of (in this example, four) hollow fiber separation membrane modules 2 suspended therein. Furthermore, each hollow fiber membrane module is provided with a membrane aerating air diffusion device with its air supply pipe. Furthermore, a bioaerating air diffusion device 6 is disposed in an area under a membrane unit including hollow fiber membrane module 2 and membrane aerating air diffusion device 8.

A bioaerating air supply pipe 5 and a membrane aerating air supply pipe 7 are connected to an air supply source (or a blower) 9, inserted at an upper portion of vessel 1 and extend downward along a sidewall 1a, have their respective lower ends bent at a position adjacent to a bottom wall 1b and therefrom extend horizontally, and are connected to bioaerating air diffusion device 6 provided at bottom wall 1b via a support member 11, and to membrane aerating air diffusion device 8, respectively.

An air diffusion plate 10 having a large number of spaced air diffusion holes A1 is deposited on an upper surface of bioaerating air diffusion device 6 to jet air that is introduced in bioaerating air diffusion device 6 throughout the area having the membrane modules disposed therein. Air diffusion hole A1 has a relatively small diameter for example of 0.5 mm and is adapted to jet small bubbles of approximately 1 mm in diameter.

Vessel 1 is internally provided with a dissolved oxygen meter (not shown) to measure dissolved oxygen required for biotreatment. Depending on the amount of oxygen dissolved, a control device 50 described later automatically controls an amount of air supplied to bioaerating air supply pipe 5 or the like to supply necessary minimum fine bubbles intermittently through bioaerating air supply pipe 5 and bioaerating air diffusion device 6 to vessel 1.

Hollow fiber membrane module 2 suspended in vessel 1 has an upper end with a securing member 15 and a pipe 16 for permeating liquid through membrane (or a water collecting pipe) is secured to securing member 15 and also inserted through an attachment hole provided through a lid plate 13 of vessel 1, and a flange 16a secured to pipe 16 for permeating liquid through membrane is secured to lid plate 13. Pipe 16 for permeating liquid through membrane has an electromagnetic opening/closing valve 17 interposed and furthermore, a suction pump 19 interposed understream thereof.

Furthermore, vessel 1 is supplied with raw water Q through a raw water supply pipe 4 passed through a piping hole provided through lid plate 13. The pipe is provided with an electromagnetic opening/closing valve 18 to open/close a raw water supply path.

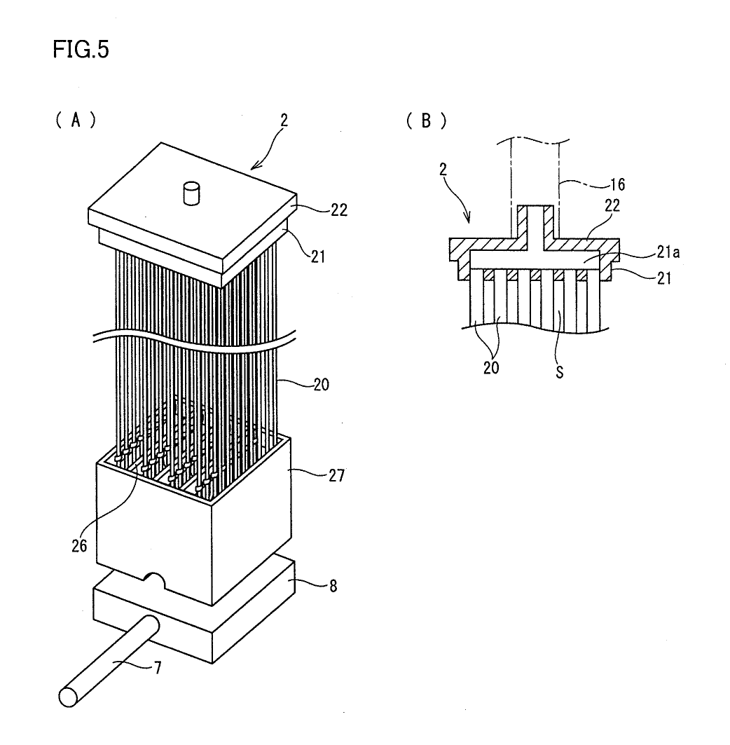

Hollow fiber membrane module 2 has a large number of expanded PTFE hollow fiber membranes 20 bundled in a rectangle (or a circle) as seen in a horizontal cross section, as shown in FIG. 5(A). Each hollow fiber membrane 20 is folded in two in the form of the letter U and disposed side by side with a gap, and has upper ends connected and secured by a sealing and securing member 21. Sealing and securing member 21 is provided with a water collecting portion 21a communicating with a hollow portion of each hollow fiber membrane 20, a water collecting header 22 is fitted to water collecting portion 21a externally and thus secured thereto, and water collecting header 22 is connected to pipe 16 for permeating liquid through membrane, as shown in FIG. 5(B).

In contrast, each hollow fiber membrane 20 has a lower end having a curved portion with a support rod 26 passed therethrough to maintain a form of the letter U. Hollow fiber separation membrane module 2 has hollow fiber membrane 20 folded via the support rod and also spaced to form a gap S to facilitate passing air diffusing bubbles and raw water. Support rod 26 is held by a holding member 27 serving as a frame externally surrounding a lower end of hollow fiber membrane module 2, and holding member 27 extends further downward to form a skirt (or an extended wall) in the form of a rectangular parallelepiped surrounding a space under hollow fiber membrane 20.

Under the skirt in the form of the rectangular parallelepiped is disposed membrane aerating air diffusion device 8 in the form of a shallow rectangular parallelepiped. It has an upper surface having a size corresponding to the total projected area of hollow fiber separation membrane module 2, and the upper surface is provided with a large number of air diffusion holes A2 having a small diameter and mutually spaced frontward, rearward, rightward and leftward to serve as air jetting ports. These air diffusion holes A2 are adapted to correspond to all gaps S between hollow fiber membranes 20.

The distance from the upper surface of membrane aerating air diffusion device 8 provided with air diffusion holes A2 to hollow fiber membrane 20 can be set, as desired, depending on the length of holding member 27 secured to the membrane module. Holding member 27 having larger lengths allows bubbles jetted through air diffusion holes A2 to be rapidly increased and hollow fiber membrane 20 can thus be exposed to coarse bubbles.

Membrane aerating air diffusion device 8 has a side surface provided with a connection port 8b for membrane aerating air supply pipe 7.

Thus membrane aerating air diffusion device 8 is attached to hollow fiber membrane module 2 at a lower end via holding member 27 and blows air through air diffusion holes A2 locally and directly to all gaps S between hollow fiber membranes 20. Alternatively, the membrane aerating air diffusion device may be attached with an appropriate distance specifically of 5-50 mm, desirably 10-30 mm to a lower end of holding member 27. This can reduce a solid content which remains and deposits on a surface of the air diffusion device. On the other hand, bioaerating air diffusion device 6 disposed under membrane aerating air diffusion device 8 provides aeration towards the membrane module unit area generally.

Hollow fiber membrane module 2 has hollow fiber membrane 20 formed, in this embodiment, of porous, multilayered hollow fiber membrane. The multilayered hollow fiber membrane has a support layer of tubular porous expanded PTFE and a filtering layer of porous expanded PTFE sheet wound on an external circumferential surface of the support layer in contact therewith to have multiple layers for increased strength.

The filtering membrane may be formed of porous expanded PTFE sheet uniaxially or biaxially stretched. Preferably, however, unsintered powdery PTFE and a liquid lubricant are paste-extruded to provide a shaped body which is in turn stretched biaxially to provide porous sheet which is in turn sintered to provide the porous expanded PTFE sheet. Biaxial stretching allows voids to be surrounded by a fibrous skeleton enhanced in strength.

Furthermore, the filtering membrane and the supporting membrane can easily form a stack of layers by sintering and thus integrating unsintered porous PTFE membrane.

Note that hollow fiber membrane 20 is not limited to the above multilayered hollow fiber membrane, and may be a monolayer. Hollow fiber membrane 20 has a filtering area having an average pore size of 0.01-5 micrometers, an average thickness (for the multilayer, the thickness of the filtering layer and that of the supporting layer added together) of 0.1-10 mm, a porosity of 40-90%, an inner diameter of 0.3-10 mm, and an IPA bubble point in a range of 10-600 kPa.

Furthermore, hollow fiber membrane 20 has tensile strength of 10N/mm² or larger as defined in JIS K 7113.

Bioaerating air supply pipe 5 connected to bioaerating air diffusion device 6 and membrane aerating air supply pipe 7 connected to membrane aerating air diffusion device 8 are piped through piping holes provided through lid plate 13, and connected via a flow control valve 45 and an opening/closing valve 46, and a flow control valve 47 and an opening/closing valve 48, respectively, to air supply source 9.

The flow control and opening/closing valves are electromagnetic valves opened/closed and controlling flow rates, as controlled by control device 50. Furthermore, opening/closing valve 17 interposed in pipe 16 for permeating liquid through membrane, opening/closing valve 18 interposed in a pipe 4a supplying liquid to be treated, and furthermore, suction pump 19 are driven by control device 50. Suction pump 19 after it is driven is stopped at a time set by a timer. Note that the opening/closing valve can also be opened/closed manually.

Control device 50 operates suction pump 19 when a filtering operation is performed, and control device 50 stops suction pump 19 when the filtering operation is stopped. In contrast, membrane aerating, opening/closing valve 46 is open constantly, i.e., even when the filtering operation is not performed, to supply air diffusing bubbles to hollow fiber membrane module 2. Furthermore, normally, liquid to be treated has a flow rate fixed, as controlled, for operation, and is sucked by an output of a suction pump for maintaining the flow rate and thus filtered. How hollow fiber membrane 20 is fouled is detected by a detector that detects suction pressure applied for filtration through the hollow fiber membrane, and when the detector detects a value reaching a threshold value, membrane aeration is increased in amount to reduce fouling, and once it has been reduced to a differential pressure, membrane aeration is decreased in amount. Furthermore, dissolved oxygen increased/decreased as membrane aeration is varied in amount is fed back to bioaeration in amount and thus controlled in amount.

The membrane aerating air supply pipe is supplied with air in a range of 10-70 kPa in pressure, more preferably, compressed air of 20-50 kPa suitably. The compressed air may be supplied from air supply source 9 in the form of a blower or a compressor. Suitably, the blower is used, as the compressor provides excessively large air pressure, while the blower is also advantageous in terms of cost.

The present invention allows a membrane separation activated sludge method to achieve a steady filtration throughput with a significantly reduced amount of air required. If an air flow rate divided by an amount of water to be filtered is defined as an air feeding ratio, the present invention provides a significantly better air feeding ratio than a conventional membrane separation activated sludge system. Hollow fiber membrane module 2 formed of PTFE has achieved an air feeding ratio better than conventional by 20% or larger. For example, for treating water in an amount of 100 L/hr, membrane aeration is set in amount in a range of 0.5 to 1.5 Nm³/hr, preferably 0.7 to 1.0 Nm³/hr, depending on activated sludge liquid's property and the like.

While the less, the better in terms of favorable energy for air-introduced operation, i.e., electric power consumed to operate the blower, i.e., a running cost, the membrane separation activated sludge process equipment configured as described above decomposes sewage or factory effluent that is introduced into vessel 1 by microorganisms under the presence of an appropriate amount of oxygen.

Liquid biotreated in vessel 1 is attracted into each hollow fiber membrane 20 of hollow fiber membrane module 2 by an action of suction pump 19, and while liquid permeating through membrane is collected through permeate pipe 16, microorganism flocs, inorganic matters and the like that activated sludge liquid contains are captured on a surface of hollow fiber membrane 20 and thus adhere thereto.

The hollow fiber membrane module 2 hollow fiber membranes 20 have gaps therebetween, which directly receive air, which forms coarse bubbles, jetted by membrane aerating air diffusion device 8 through air diffusion holes A2 and thus diffused in the gaps. As the jetted bubbles are coarse bubbles, they have energy that can sway hollow fiber membrane 20. Furthermore, each hole perforated uniformly in a plane allows the module to have each portion exposed to bubbles uniformly, and furthermore, the skirt prevents the bubbles from scattering. This allows diffused air to be effectively used and thus efficiently sway the hollow fiber membrane, and can consequently contribute to a reduced amount of air to be jetted.

Furthermore, hollow fiber membrane module 2 having each hollow fiber membrane 20 with a lower portion supported with gap S therebetween allows air passing through gap S of each hollow fiber to be loaded on a surface of hollow fiber membrane 20 and the liquid that flows adjacent to the surface ensures that a suspended component deposited on the surface or between the membranes can efficiently be removed. Furthermore, the hollow fiber membrane module having hollow fibers bundled together that can be thoroughly exposed to sufficient bubbles can have a lower portion without a solid content deposited thereon and thus ensures a steady filtration function.

In particular, hollow fiber membrane module 2 formed of hollow fiber membrane 20 of PTFE having large strength is advantageous as it can be operated for filtration with continuous air diffusion without damaging/creasing hollow fiber.

Furthermore, when bioaerating air diffusion device 6 under membrane aerating air diffusion device 8 jets air, bubbles move upward at an external peripheral portion of hollow fiber membrane module 2 and thus also provide an advantageous effect to enhance the hollow fiber's vibration and a swirling stream.

Normally, bioaerating air diffusion device 6 provides aeration through air diffusion holes A1 constantly even when filtration is not provided. In doing so, air diffusion holes A1 jet air in small bubbles, which are dissolvable and can thus contribute to a reduced amount of air to be supplied.

Furthermore, the bioaerating and membrane aerating air supply pipes provided with opening/closing valves, respectively, that are automatically controlled individually, allow vessel 1 to receive aeration to maintain dissolved oxygen concentration proper for microorganisms, and also allow hollow fiber membrane module 2 to constantly receive air to diffuse it to reduce fouling.

FIG. 8 shows the first embodiment in an exemplary variation.

While the first embodiment provides hollow fiber membrane module 2 having each hollow fiber membrane 20 in a form of the letter U to have a lower end turned, the support rod may be dispensed with and a support member 65 in a form of the letter U in cross section can instead be used to sandwich and secure the lower end therein. A plurality of support members 65 spaced S as appropriate are disposed inside frame 27 externally surrounding the lower end.

A membrane aerating air diffusion device is coupled with frame 27 via a skirt member, as done in the first embodiment, and the remainder in configuration is also similar and provides a similar function and effect, and accordingly, will not be described repeatedly.

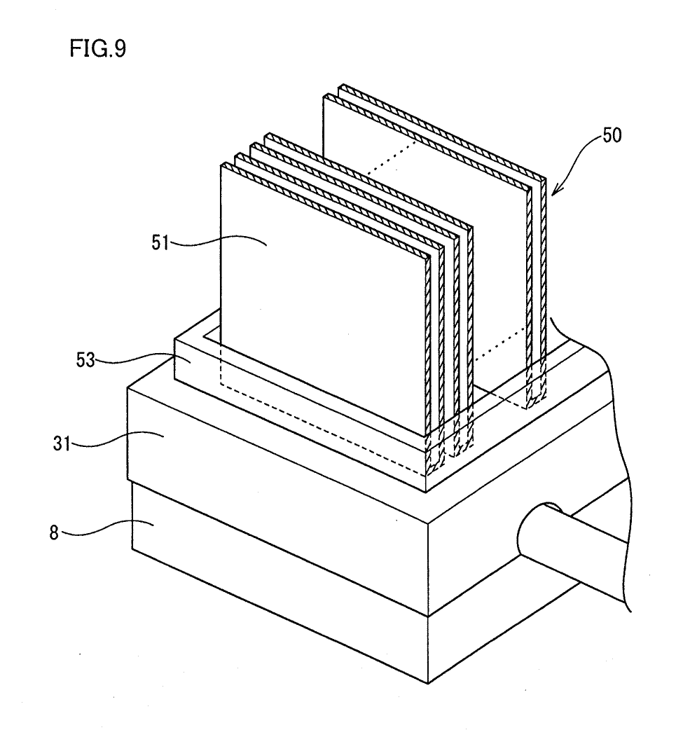

FIG. 9 shows a second embodiment.

The second embodiment provides a separation membrane module 50 as a flat sheet separation membrane module having flat sheet membranes 51 disposed adjacently. Adjacent flat sheet membranes 51 are housed inside a frame 53 surrounding their lower ends and can be swayed as desired, similarly as done in the first embodiment. Membrane aerating air diffusion device 8 is attached to frame 53 via a holding member 31, similarly as done in the first embodiment. Furthermore, the remainder in configuration is also similar to the first embodiment and provides a similar function and effect, and accordingly, will not be described repeatedly.

FIG. 10 shows a third embodiment. A membrane aeration device has membrane aerating air diffusion device 8 attached, with an appropriate distance X specifically of 5-50 mm, desirably 10-30 mm to the lower end of holding member 27. The remainder in configuration is also similar and provides a similar effect, and accordingly, will not be described repeatedly, although this example can additionally reduce a solid content which remains and deposits on a surface of the air diffusion device.

Exemplary Experiments

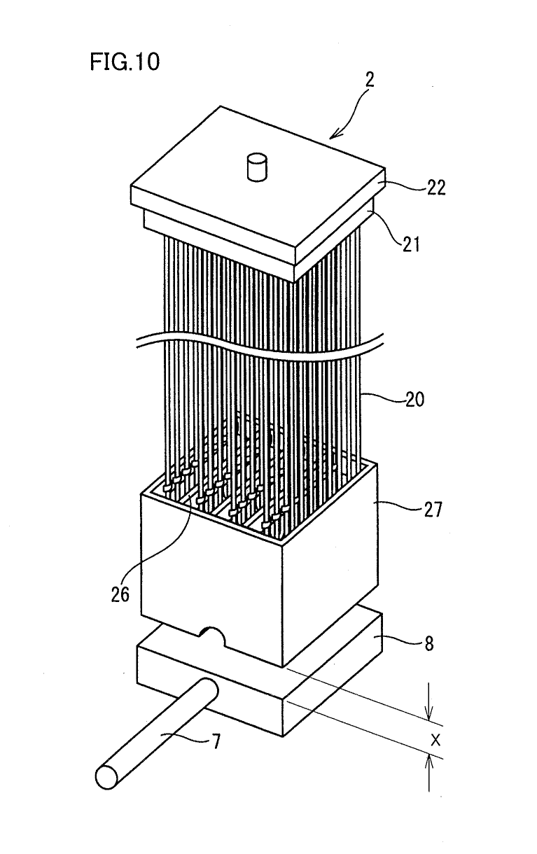

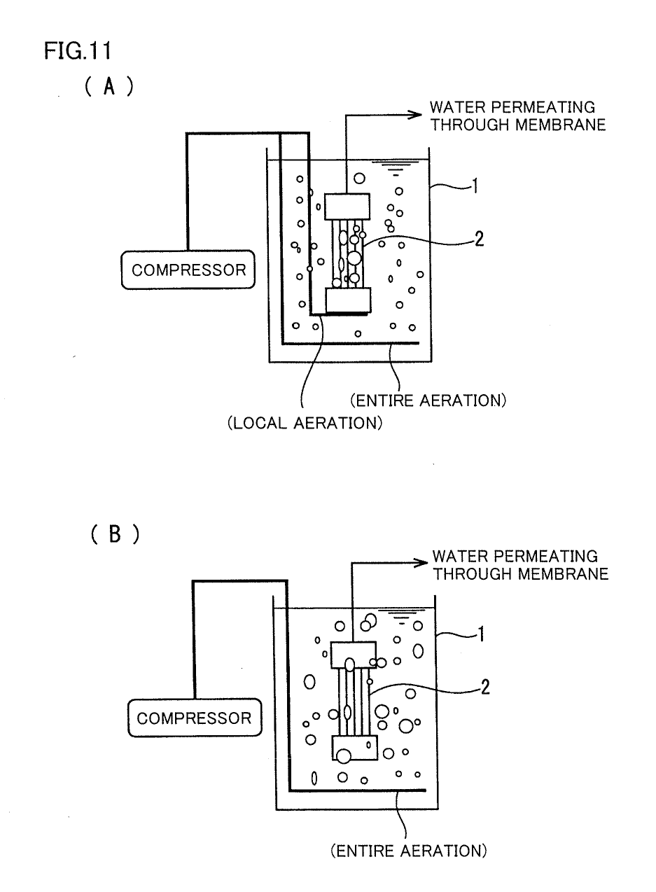

FIG. 11 (A) shows the present, locally aerating, membrane aerating air supply means and bioaerating air supply means together provided, i.e., the afore-described first example of the present invention, and FIG. 11(B) shows a comparative example providing only an aerating air supply means to provide entire aeration in a vessel. Their separation membrane modules had their separation membranes measured for total filtration resistance.

For a set flux (i.e., a flow rate per unit membrane area) of 0.8 m/day, the example of the present invention provided only local aeration and the comparative example provided only entire aeration, and they both provided aeration (or supplied air) in equal amounts.

The examples both provided aeration in a varying amount of 1500 l/h, 2000 l/h, 2500 L/h, and 3000 l/h, and provided a continuous, two-week operation for each amount.

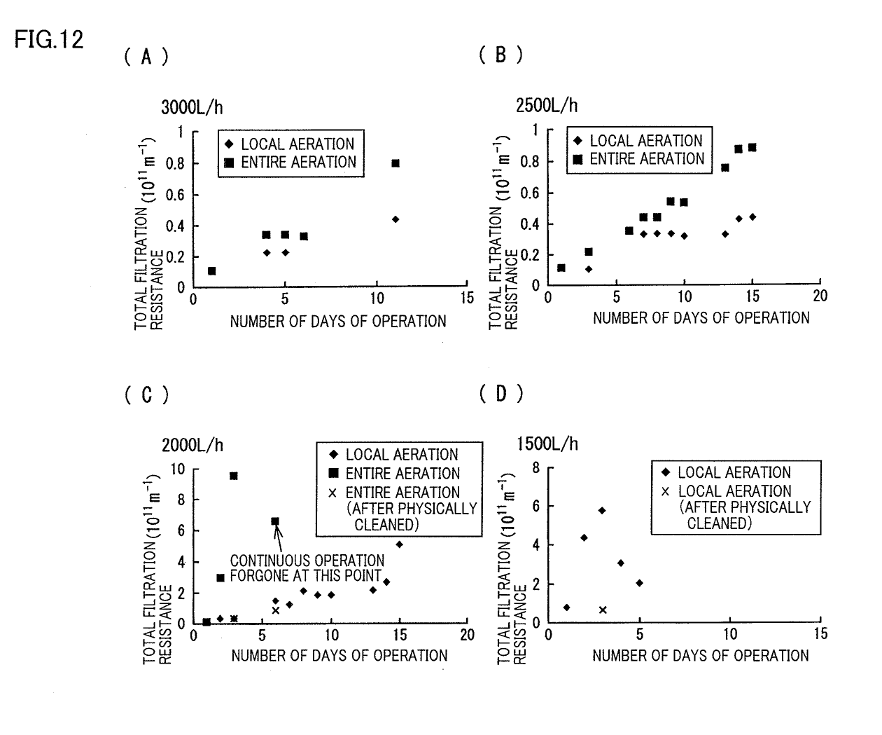

The result is shown in graphs shown in FIGS. 12(A) to 12(D). In each graph, diamonds represent the present example's local aeration, and squares represent the comparative example's entire aeration.

As is apparent from FIGS. 12(A) to 12(D), it has been confirmed that the example of the present invention providing local aeration provides small total filtration resistance and thus allows a separation membrane module to have hollow fiber membrane with a surface cleaned more effectively than the comparative example providing entire aeration.

The present invention is not limited to the above embodiments, and can be provided in a variety of forms in a range which is not beyond the gist of the present invention. For example, while the above embodiments provide a membrane aerating air diffusion device attached to a lower end of an extended wall extending from a lower portion of a separation membrane module, the membrane aerating air diffusion device may be remote from the extended wall and disposed around and downward of (a space inside) the extended wall. Guiding bubbles that are jetted from the membrane aerating air diffusion device along the extended wall to the separation membrane module in a major amount, suffices. Furthermore, the membrane aerating air diffusion device or the extended wall may be provided with an introduction hole for guiding bioaerating fine bubbles, raw water and the like to the extended wall's internal space.

### REFERENCE SIGNS LIST

1: vessel
2: hollow fiber membrane module
5: bioaerating air supply pipe
6: bioaerating air diffusion device
7: membrane aerating air supply pipe
8: membrane aerating air diffusion device
20: hollow fiber membrane
27: holding member
50: control device
A1, A2: air diffusion hole

1. An immersion type membrane module unit comprising:
an immersion type membrane module for membrane separation activated sludge filtration;
an extended wall extending from a lower end of said membrane module and surrounding a space downward of said membrane module; and
a membrane aerating air diffusion device disposed at one of a lower portion in said space and a position around and downward of said space and having a plurality of air diffusion holes arranged in a matrix,
said membrane module having separation membranes with gaps therebetween, said extended wall guiding bubbles from said air diffusion holes to said gaps.

2. The immersion type membrane module unit according to claim 1, wherein:
said air diffusion device has an upper surface covering a projected area of said membrane module; and
said plurality of air diffusion holes are provided at said upper surface.

3. The immersion type membrane module unit according to claim 1, wherein said plurality of air diffusion holes are provided uniformly to correspond to said gaps of said separation membranes.

4. The immersion type membrane module unit according to claim 1, wherein said membrane module is one of a hollow fiber membrane module and a flat sheet membrane module.

5. The immersion type membrane module unit according to claim 1, wherein said separation membrane is formed of PTFE.

6. The immersion type membrane module unit according to claim 5, wherein said membrane module is formed with hollow fiber membranes of PTFE bundled together.

7. The immersion type membrane module unit according to claim 6, wherein said hollow fiber membrane of said membrane module has an average pore diameter equal to or larger than 0.01 micrometers, an average thickness equal to or larger than 10 micrometers, and a tensile strength equal to or larger than 10N/mm² as defined in JIS K 7113.

8. Membrane separation activated sludge process equipment of a single vessel type providing biotreatment and membrane separation within a single vessel, having in an activated sludge tank:
an immersion type membrane module unit according to claim 1; and
a bioaerating air diffusion device underlying said membrane module unit and independent of said air diffusion device provided to supply oxygen to activated sludge.

9. The membrane separation activated sludge process equipment according to claim 8, wherein said air diffusion device of said immersion type membrane module unit supplies said separation membrane module with coarse bubbles for aeration to clean membrane and said bioaerating air diffusion device supplies fine bubbles.

10. The membrane separation activated sludge process equipment according to claim 8, further comprising a control device to control said air diffusion device and said bioaerating air diffusion device independently.
